(19) United States
(12) Patent Application Publication
(10) Pub. No.: US 2024/0222948 A1
(43) Pub. Date: Jul. 4, 2024

(54) DISTRIBUTION SYSTEM FOR A VEHICLE ELECTRICAL SYSTEM AND SUPPLY TRAIN FOR SUCH A DISTRIBUTION SYSTEM

(71) Applicant: LEONI Bordnetz-Systeme GmbH, Kitzingen (DE)

(72) Inventor: Volker Hoffmann, Kitzingen (DE)

(21) Appl. No.: 18/550,740

(22) PCT Filed: Mar. 14, 2022
(86) PCT No.: PCT/EP2022/056578

§ 371 Date: Sep. 15, 2023

(30) Foreign Application Priority Data
Mar. 15, 2021 (DE) 10 2021 202 496.3

(51) Int. Cl. H02G 3/04; B60R 16/02; H01B 17/56; H02G 3/30

(52) U.S. Cl. CPC H02G 3/045; B60R 16/0215; H01B 17/56; H02G 3/30

(57) ABSTRACT

A distribution system for an on-board vehicle electrical system of a motor vehicle has an on-board electrical structure, particularly a zonal structure. The on-board electrical structure has a supply train which, when mounted, supplies power to components connected at the end of the supply train. The supply train contains an insulating substrate having a plurality of longitudinal grooves each insulated from one another, into which bare solid conductors are laid and particularly clipped in.

The present invention relates to a distribution system, in particular a current distribution system for an electrical system of a motor vehicle, in particular for an electrical system with a modular/zonal electrical system structure. The distribution system has a supply line which, in the installed state, serves for the supply, in particular the power supply, of components connected to the supply line. The invention furthermore relates to such a supply line.

In DE 10 2012 200 979 A1, a supply line is provided for supplying energy in an electrical system of a motor vehicle, in which a plurality of conductors are arranged in the manner of conductor rails within a common insulating casing. This line connects a plurality of spatially separated regions within the vehicle to one another.

Current developments in motor vehicle electrical systems are tending toward decentralized power distribution structures. This simplifies the electrical system structure. In particular, for this purpose, what is referred to as a zonal electrical system architecture is provided, in which the electrical system is divided into different, spatially separated zones within the motor vehicle. Each of said zones is typically assigned a decentralized and preferably also standardized control device, which is also referred to as a zone control device and via which the required functions in a respective zone are activated. The individual control devices are connected to a supply line specifically for supplying power, in order to supply the loads connected to the respective control device with power and current.

Proceeding from this, the present invention is based on the object of permitting a simple and cost-effective connection between two components, specifically between two such decentralized control devices within a zonal electrical system structure.

The object is achieved according to the invention by a distribution system for an electrical system of a motor vehicle, having a preferably zonal electrical system structure, and by a supply line for such a distribution system. The distribution system has the supply line which, in the installed state, serves for the power supply of components preferably connected on the end sides to the supply line, in particular decentralized control devices. The supply line has an insulating carrier with a plurality of longitudinal grooves which are delimited from one another in an insulating manner. Bare and solid conductors are placed into them and in particular also held in the longitudinal grooves. The conductors are loosely placed and held overall in the insulating carrier without being connected, e.g. materially, to the insulating carrier.

The supply line is used preferably for both a positive supply and the feedback of the ground connection, this being increasingly required in modern vehicles. The supply line therefore has at least two conductors, with the one being connected to a positive terminal of a current source and the other to ground potential in a DC electrical system.

The supply line serves in particular for the power supply of the connected components. Additionally or alternatively, it also serves for the data supply of the connected components.

The supply line has, as a separate, independent constructional unit, the insulating carrier with the longitudinal grooves which are introduced therein, form channels which are delimited with respect to one another and in which the solid conductors are placed. This measure achieves a simple and also simply scalable construction. Thus, depending on requirements, a different number of conductors can be introduced into the insulating carrier. Therefore, in the installed state, depending on the occupancy and requirements, some longitudinal grooves may be unused. A particular advantage can be seen in the fact that there is no connection, in particular no integrally bonded connection, between the conductor and insulating part. The insulating carrier can therefore be pre-manufactured independently of the conductors. The insulating carrier is therefore an independent, pre-manufactured component. In the same way, the solid and bare conductors are preferably also provided cost-effectively as endless products which are cut to a desired conductor length.

The insulating carrier is designed in such a manner that the conductors can be introduced retrospectively therein. The conductors can be placed in particular from above into the respective longitudinal groove and/or can be pushed into the respective longitudinal groove in a longitudinal direction thereof.

The insulating carrier to this extent also forms a type of cable duct for receiving the conductors in the individual longitudinal grooves. The cross section of the insulating carrier is preferably constant here over its entire length. The width of the insulating carrier preferably corresponds here to the sum of the longitudinal grooves arranged next to one another together with the groove walls laterally bounding the longitudinal grooves.

The supply line serves in particular for the power supply and the individual conductors preferably have a sufficiently large cross-sectional area for transmitting currents of several amperes, preferably of several 10 A or else of more than 50 A or of more than 100 A. The cross-sectional area of the conductors, which are in particular in the form of copper conductors, lies, for example, in a range of between 2 mm² and 10 mm², preferably in the range between 3 mm² and 5 mm² and especially is 4 mm².

In comparison to conventionally used supply lines with a plurality of individual wires which each have wire insulation, both volume and weight can be saved by the configuration described here. In particular also since stranded conductors are used for conventional wires. The described construction with the insulating carrier and the conductors placed therein also permits a high degree of variability and thus also configurability. Specifically, even retrospective changes are easily possible. Furthermore, the temperature load is improved, and therefore improved thermal management for example in the configuration of the supply line is made possible and the conductors can optionally be re-dimensioned compared to conventional wires. Furthermore, placing the conductors only loosely into the insulating carrier makes susbsequent recycling much easier.

Where a bare conductor is referred to here, this should be understood as meaning a conductor which does not have any insulation, i.e. in particular does not have any insulation casing in the form of conventional wire insulation. The conductor is also not embedded in insulating material, as is the case for example in conventional flat conductors or in the case of the supply line known from the prior art mentioned at the beginning. One advantage of said bare design of the conductors can also be seen in the fact that center taps in particular in the manner of what is referred to as direct contact are thereby made possible in a simple manner, for example by a branching conductor being connected directly in a material bonded manner, for example by friction welding. Simple connection of further components is therefore made possible.

The insulation and galvanic isolation of the conductors with respect to one another takes place via the insulating carrier. The latter is composed, for example, of plastic. The simple construction of such plastics carriers means that they can be extruded in the form of products by the meter. The longitudinal grooves extend in particular over the entire length of the insulating carrier. According to a preferred embodiment variant, said insulating carrier extends continuously linearly and does not have any branches and/or bends. It preferably runs within a plane.

The entire supply line can also be considered to be a busbar or profiled supply rail.

In a preferred refinement, the conductors are in the form of solid round conductors. Owing to their circular cross-sectional geometry, round conductors have a number of advantages in particular even over rails with a rectangular cross section. Specifically, they afford advantages during the laying, in particular during the placing into the insulating carrier.

The conductor material used is preferably copper or alternatively also aluminum.

In an expedient development, the insulating carrier has a base part with the longitudinal grooves, which base part is open upward, and therefore the conductors can be placed, and in particular pressed in, from above in a simple manner into the base part. The conductors are therefore placed in perpendicularly to their longitudinal direction and perpendicularly to the longitudinal grooves. The base part is substantially U-shaped with at least one additional partition, preferably with a plurality of individual partitions, by means of which the longitudinal grooves are delimited from one another. The cross-sectional geometry of the insulating carrier, specifically of the longitudinal grooves together with the walls (groove walls) bounding them, is preferably identical before and after the conductors are placed therein. Preferably, there is merely elastic expansion of lateral walls during the placing-in operation. Material deformation, for example due to plasticizing or fusing, does not take place.

Preferably, the respective conductors are held in a form-fitting manner in a respective longitudinal groove. The form-fitting connection which is formed is effective here transversely with respect to the longitudinal direction of the longitudinal grooves, and therefore the conductors are upwardly secured against unintentionally sliding out of the longitudinal groove.

In order to form the form-fitting support, in particular the formation of an undercut is provided. For this purpose, a wall which separates two adjacent longitudinal grooves from each other is preferably widened, as viewed in cross section. The respective wall therefore forms a partition. For example, the wall is formed at its free end in the manner of a dovetail. The insulating carrier already has said widened portions in the pre-manufactured state and irrespective of whether a conductor is placed therein.

An interior space or receiving space for the conductor, the space being defined by two opposite walls, therefore tapers upward. The cross-sectional contour of the receiving space is preferably adapted here to the cross-sectional contour of the conductor, i.e. when a round conductor is used, the wall portions bounding the longitudinal groove are preferably each curved (convexly).

An opening slot formed on the upper side between two walls overall has an opening width which is smaller than the width and specifically than the diameter of a respective conductor.

The walls are preferably elastic, and therefore they yield elastically laterally, i.e. perpendicularly to the longitudinal direction of the conductor, in particular in the region of the opening slot. By this means, simple clipping of the conductors into a respective longitudinal groove is made possible. The elastic yielding enables the walls to return back into their original position again after the conductors are inserted.

The individual walls and in particular also the undercuts extend preferably continuously over the entire length of the insulating carrier. Alternatively to the special shaping of the walls to form the undercut, elements for forming the undercut, for example in the form of holding elements, specifically holding lugs, may also be arranged in certain sections. Preferably, both the holding lugs and the specially shaped walls for forming the undercut are in each case integral and therefore monolithic parts of the insulating carrier.

In a preferred refinement, the insulating carrier has at least one base part which is in the form of a (plastics) extruded part. The insulating carrier, in particular the base part, is therefore designed in the manner of a profiled rail with the cross-sectional profile remaining constant in cross section over the entire length.

The longitudinal grooves are preferably identical to one another, i.e. have the identical cross-sectional area. Preferably, the same is also true of the conductors, i.e. all of the solid conductors placed into the longitudinal grooves have the same cross-sectional area.

In a preferred refinement, the insulating carrier has, in addition to the base part, a cover which is fastened to the base part in particular as an independent, pre-manufactured component, specifically preferably in particular in an integrally bonded manner. For the integrally bonded fastening, the cover is connected to the base part, for example, by adhesive bonding, welding, for example friction welding, or in some other way. As an alternative to the integrally bonded fastening, the cover is fastened mechanically to the base part for example by being latched thereon. The cover reliably protects the conductors. The cover extends in particular continuously and without interruption over the entire length of the base part. In particular, additional insulating protection is thereby achieved.

Preferably, at least one of the conductors protrudes and preferably all of the conductors protrude on the end side and in particular also on both end sides beyond the insulating carrier such that free conductor ends are formed. The latter each define a contact tongue which serves for electrical contact of the conductor with a following component and, in the connected state, is also correspondingly inserted. Said contact tongue is preferably provided with a contact layer for improving the electrical transition contact. For this purpose, the conductor end is, for example, silver-plated or tin-plated.

The contact tongue is specifically in the form of a plug-in contact tongue which, in the connected state, is plugged into a plug part. The solid configuration of the respective conductor means that the conductors have a high degree of rigidity, and therefore they are already directly suitable as plug-in contacts for plugging into a respective plug part and are also used as such.

As an alternative to plugging into a plug part, there is the possibility that, for example, a contact element, in particular in the form of a cable lug, is fastened to a respective contact tongue, with the contact with a component then taking place by the cable lug, for example via a screw fastening.

In an expedient refinement, the contact tongue of at least one of the conductors is and preferably the contact tongues of a plurality of conductors are angled. This is understood as meaning that the conductor end is oriented in a different direction than a longitudinal direction defined by the insulating carrier and the longitudinal grooves.

Different conductor ends are preferably oriented differently. In particular, in each case groups of conductor ends are oriented differently. By this means, more connection space is created, for example, for a plurality of plug parts, with preferably a respective plug part receiving a group of conductor ends.

The plug part is, for example, a plug part which is attached to a housing of a component such that direct electrical contact with the component, specifically with a decentralized control device, therefore takes place via said plug part. Alternatively thereto, the plug part is a plug part of a connecting or intermediate line via which the component or the control device is connected. Said line is in particular a conventional cable line.

According to a first embodiment variant, the conductors are connected exclusively on both end sides to a component, specifically to a control device. A direct 1:1 connection therefore takes place without there being an additional contact or an additional connection of a conductor or a component over the longitudinal extent of the supply line.

Alternatively thereto, provision is made, in an expedient refinement, that a branching conductor is in each case connected at least to one of the conductors, preferably to a group of conductors. Said branching conductor is preferably connected to the conductor via an integrally bonded connection, for example via what is referred to as bonding or by welding. This measure results in the formation, for example, of branches to further components or else a connection to a further supply line of identical construction.

The branching via the branching conductor can be a conventional cable connection. Alternatively, the branching preferably takes place in turn via an identical supply line, i.e. with an insulating carrier which has longitudinal grooves into which the branching conductor is placed, in particular clipped, as a bare and in particular also solid conductor. In a preferred refinement, in the region of the branch, the walls of the longitudinal grooves are laterally interrupted and the branching conductor is passed through them.

The insulating carrier is expediently fastened in the installed state to a supporting structure of the motor vehicle or is part of such. In the first case, the insulating carrier is a separate component which is fastened to the supporting structure. In the second case, a supporting structure which is present is used or at least adapted for the insulating carrier. This is, for example, a trim panel or body component. That is to say, the supporting structure itself has longitudinal grooves into which the conductors are placed. This embodiment variant specifically results in a low additional weight. Separate cable ducts in which insulated lines are guided are generally omitted.

The supply line preferably connects a front region of the motor vehicle to a rear region, i.e. it leads, for example, from a front region into a rear region of the motor vehicle. A supporting structure is understood as meaning any structure which has sufficient inherent strength to receive the supply line and the associated loadings. The supporting structure is, for example, a body component, specifically a supporting body component, for example a longitudinal sill or a typically flat underbody specifically in an electric vehicle.

The supply line described here is used in particular in what is referred to as a zonal electrical system which has a plurality of zones spaced apart spatially from one another. The supply line here connects a plurality of zones, i.e. at least two and preferably precisely two zones to one another. Preferably, each zone has in each case a decentralized control device and the supply line connects at least two and preferably precisely two control devices to each other.

The zones are spatial and optionally also functionally predetermined regions within the motor vehicle. A zone of this type is, for example, the driver's or front passenger's footwell region, a rear region, a dashboard region, the engine region, etc. The decentralized control device in each case decentrally controls the loads and other electrical or electronic units, for example also actuators or sensors etc., contained in the respective zone. For this purpose, the decentralized control devices conventionally have processing units, i.e. intelligence, in order, for example, to evaluate sensor signals or data signals and to activate the loads depending thereon. The decentralized control devices are conventionally connected to a central control device and communicate therewith via data lines, in particular via a databus.

Accordingly, provision is made, in a preferred refinement, that, in addition to the conductors for the power supply, data lines are also laid within the supply line. Said data lines are in the form, for example, of conventional, insulated and, for example, shielded data lines. They can also be clipped into a longitudinal groove. Alternatively, a conductor is used as a combined data and power conductor both for the data line and for the current and power supply.

In a preferred development, two preferably redundant supply lines are provided which specifically run from a front vehicle part to a rear vehicle part. Specifically in the case of the redundant configuration, provision is made, for example, that the two supply lines are connected to each other via transverse connections. For this purpose, for example, conductors which are redundant with respect to one another are in each case connected to one another via a branching conductor.

Preferably, two lateral supply lines are connected to each other via two transverse connections, which are spaced apart from each other in the longitudinal direction and run in particular in the region of the connected components, thus forming a supply ring.

The at least one supply line, in particular a supply ring of this type or part thereof, preferably forms what is referred to as a backbone in a motor vehicle. Such a backbone is a main power line in an electrical system, specifically in a hybrid or electric vehicle with a drive motor driven electromotively. The backbone serves, for example, (also) for the power supply of such an electric drive motor.

The two supply lines are arranged, for example, on parallel longitudinal structures of the vehicle, for example running along the longitudinal sills.

In a preferred refinement, two or more adjacent conductors conduct an identical potential during operation. Said plurality of conductors are furthermore preferably connected to one another, i.e. can be bridged, for example, during the feeding and/or at the load in order therefore to obtain higher cross-sectional values and a higher current-carrying capability, in particular without increasing the variance of too many cross-sectional values. The individual conductors therefore preferably have identical cross-sectional values.

An exemplary embodiment of the invention will be explained in more detail below with reference to the figures. In the latter, in sometimes greatly simplified illustrations:

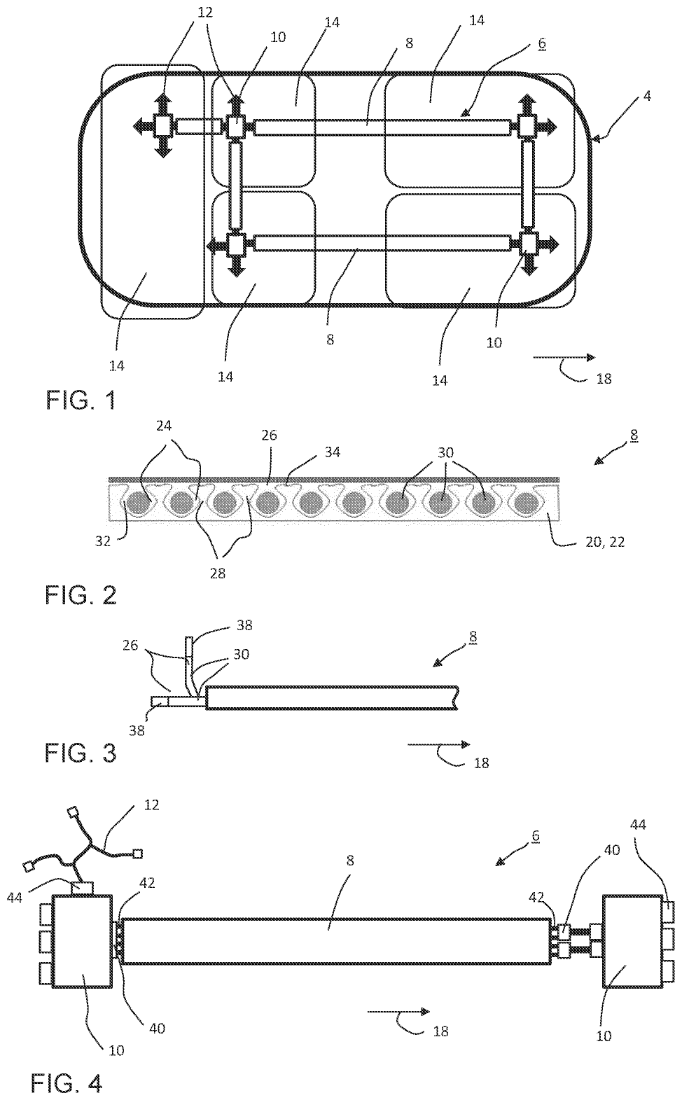

FIG. 1 shows a greatly simplified illustration of a motor vehicle having a zonal electrical system structure with two supply lines arranged parallel to each other,

FIG. 2 shows a cross-sectional illustration through a supply line,

FIG. 3 shows part of a lateral illustration of a supply line with conductor ends protruding on the end side in the manner of plug-in contact tongues, and

FIG. 4 shows a side view of a supply line with decentralized control devices connected thereto on the end sides.

In the figures, identically acting parts are provided with the same reference signs.

A motor vehicle 4 illustrated highly schematically in FIG. 1 has an electrical system with a zonal electrical system structure. The electrical system has a distribution system 6 which, in the exemplary embodiment, has a plurality of supply lines 8 and a plurality of decentralized control devices 10. One or more partial line sets 12 are connected to the individual decentralized control devices 10 in each case, for example, via plug-in connections (compare in this respect FIG. 4 by way of example).

In the exemplary embodiment, the electrical system has five zones 14, wherein a decentralized control device 10 is assigned to each zone 14. The distribution system 6 is in principle attached in a manner not illustrated specifically here to a current source, for example a battery or else a generator.

In the exemplary embodiment, the distribution system 6 is in the form of a power or current distribution system and serves for the power supply of the connected components. The at least one supply line 8 is preferably a central supply line, i.e. a main distribution line, also referred to as a backbone. Such a backbone typically extends in a longitudinal direction 18 from a front motor vehicle part to a rear motor vehicle part and serves, for example, also for the energy supply of an electric drive motor in a hybrid or electric vehicle.

The electrical power is preferably fed into the at least one supply line 8 via one or two feeding points, in particular via one or two decentralized (zone) control devices 10.

As can furthermore be gathered from FIG. 1, a front zone 14 is connected to a rear zone 14 via a respective supply line 8, which extends in each case in the longitudinal direction 18, specifically the decentralized control devices 10 are in each case connected directly to the supply line 8. In addition, it is illustrated in FIG. 1 that two further supply lines 8 are provided for the transverse connection in the front region and in the rear region of the motor vehicle, said supply lines each connecting two front zones and two rear zones and here in turn the control devices 10 thereof to one another. Overall, this results in the formation of a supply ring which preferably forms a backbone of the vehicle.

Alternatively or optionally also additionally to the ring structure illustrated, there is the possibility that (only) one, for example centrally arranged, supply line 8 extending in the longitudinal direction 18 is in the form, as it were, of a central backbone and connects two zones to each other.

It can be seen with reference to the cross-sectional illustration of a supply line according to FIG. 2 that said supply line has an insulating carrier 20 which, in turn, comprises a base part 22 in which a plurality of longitudinal grooves 24 arranged next to one another are formed. The longitudinal grooves 24 extend in the longitudinal direction 18. The individual longitudinal grooves 24 are open upward. An opening slot 26 is therefore defined on said open side. The individual longitudinal grooves 24 are delimited from one another in each case in an insulating manner by walls 28. Two adjacent walls 28 enclose a receiving space between them which is designed for receiving a respective conductor 30. In the exemplary embodiment, all of the longitudinal grooves 24 are occupied by one conductor 30 each. The conductors 30 are bare, solid conductors, i.e. the conductors are composed of solid material and are formed without insulation. In the exemplary embodiment, round conductors are provided. In the exemplary embodiment, the receiving spaces are preferably likewise adapted to the round geometry of the conductors 30 and, as viewed in cross section, are likewise at least substantially circular.

The receiving space tapers upward toward the opening slot 26 such that an undercut 32 is in each case formed. The wall 28 therefore overlaps the respective conductor 30 in the region of the opening slot 26 such that said conductor is held in a form-fitting manner. The walls 28 are generally elastic, and therefore the respective conductor 30 can be clipped in a simple manner from above into the respective longitudinal groove 24. Alternatively, there is also the possibility that the conductors 30 are pushed in the longitudinal direction 18 into the longitudinal grooves 24.

The base part 22 is therefore designed overall in the manner of an upwardly open cable duct which has a plurality of partitions, which are formed by the walls 28, for forming the individual longitudinal grooves 26. The base part 22 typically has a width which is formed by the number of longitudinal grooves and the walls 28 bounding them. The walls typically have a width which is smaller than the width of the longitudinal grooves.

The insulating carrier 20 furthermore has a cover 34 which closes the longitudinal grooves 24 upward. The cover 34 is connected to the base part 22 preferably in an integrally bonded manner, for example by welding.

According to a preferred development, not illustrated specifically, the supply line 8 has two or more levels, wherein a plurality of conductors 30 are arranged next to one another on each level in a manner separated by walls 28.

Preferably, each level has an insulating carrier 20 with the longitudinal grooves 24. The insulating carriers 20 are arranged one above another; specifically, the opening slots 26 are oriented in the same direction. Preferably, the base of the one insulating carrier 20 forms a cover for the insulating carrier 24 located therebelow.

Preferably, a separate cover 34 is provided only for the upper insulating carrier 20.

According to an alternative embodiment variant, the opening slots 26 of the two insulating carriers 20 face each other.

The two insulating carriers 20 are preferably each in the form of independent and in particular identical constructional units. They are, for example, fastened suitably to each other.

As can be seen with reference to FIG. 3, in a preferred refinement the individual conductors 30, preferably all of the conductors 30, protrude on the end sides beyond the insulating carrier 20 in or counter to the longitudinal direction 18 and, with the protruding partial region, form plug-in contact tongues 36. For this purpose, the end pieces of the conductors 30 are preferably provided with a contact coating 38 and, for example, are silver-plated or tin-plated.

In the installed state, said plug-in contact tongues 36 are preferably plugged directly into a plug part 40 for contacting the conductors, as can be gathered for example with reference to FIG. 4.

The latter shows a supply line 8 which is attached on both end sides to a respective decentralized control device 10. The left half of the figure shows a situation in which the individual plug-in contact tongues 36 are plugged directly into a plug part 40 of the control device 10. The plug part 40 is part of a housing of the control device 10. On the right half of the figure, the control device 10 is attached via an intermediate cable 42 which, in turn, is connected via here two plug parts 40 to the plug-in contact tongues 36 of the supply line 8.

The decentralized control devices 10 typically have a plurality of interfaces customarily in the form of plug-in ports 44 via which a respective partial line set 12 can be attached. Such a partial line set is illustrated by way of example in the left half of the figure. Said partial line sets 12 typically have a branched structure and, on the end sides, typically in turn have plugs with which they are attached to individual components or loads.

The invention has been described here with reference to an exemplary embodiment, but is not restricted thereto. On the contrary, other refinements are also included within the scope of the claims. In particular, the individual features, as are set forth in particular in the claims, can be combined as desired with one another without being limited to the combination of the features of the exemplary embodiment.

### LIST OF REFERENCE SIGNS

4 motor vehicle
6 distribution system
8 supply line
10 decentralized control device
12 partial line set
14 zone
18 longitudinal direction
20 insulating carrier
22 base part
24 longitudinal groove
26 opening slot
28 wall
30 conductor
32 undercut
34 cover
36 plug-in contact tongue
38 contact layer
40 plug part
42 intermediate cable
44 plug-in port

1-18. (canceled)

19. A distribution system for an electrical system of a motor vehicle, the distribution system comprising:
a supply line which, in an installed state, serves for a supply of components connected to said supply line, said supply line having a plurality of levels, each of said levels in each case having an insulating carrier with in each case a plurality of longitudinal grooves formed therein being delimited from one another in an insulating manner and into which bare and solid conductors are placed, each said insulating carrier is in a form of a pre-manufactured component into which said bare and solid conductors are inserted retrospectively, and in that two insulating carriers are disposed one above another.

20. The distribution system according to claim 19, wherein a base of one of said insulating carriers forms a cover for said insulating carrier disposed therebelow.

21. The distribution system according to claim 19, wherein a respective conductor of said bare and solid conductors is held in a form-fitting manner in a respective one of said longitudinal grooves and, for this purpose, said insulating carrier has an opening slot formed on an upper side of said insulating carrier and said opening slot has an opening width which is smaller than a width of said respective conductor, wherein said opening slots are oriented in a same direction.

22. The distribution system according to claim 19, wherein a respective conductor of said bare and solid conductors is held in a form-fitting manner in a respective one of said longitudinal grooves and, for this purpose, said insulating carrier has an opening slot formed on an upper side of said insulating carrier and said opening slot has an opening width which is smaller than a width of said respective conductor, wherein said opening slots of said insulating carriers face each other.

23. The distribution system according to claim 19, wherein said bare and solid conductors are in a form of solid round conductors.

24. The distribution system according to claim 19, wherein said insulating carriers each have a base part with said longitudinal grooves formed therein, said base part is open upward, and said bare and solid conductors are disposed from above into said base part.

25. The distribution system according to claim 19, wherein adjacent ones of said longitudinal grooves are separated from one another by a wall of said insulating carrier and said wall widens upward and forms an undercut.

26. The distribution system according to claim 19, wherein said insulating carriers are in a form of an extruded part.

27. The distribution system according to claim 19, wherein each of said insulating carriers has a base part with said longitudinal grooves formed therein and a cover which is fastened to said base part.

28. The distribution system according to claim 27, further comprising a separate cover only for an upper most one of said insulating carriers.

29. The distribution system according to claim 19, wherein at least one of said bare and solid conductors protrudes on an end side beyond said insulating carrier and forms a contact tongue for contacting said one bare and solid conductor.

30. The distribution system according to claim 19,
further comprising a plug part; and
wherein each of said bare and solid conductors has a contact tongue in a form of a plug-in contact tongue which, in a connected state, is plugged into said plug part.

31. The distribution system according to claim 30, wherein said contact tongue is angled and contact tongues of different ones of said bare and solid conductors are oriented differently.

32. The distribution system according to claim 19, further comprising a branching conductor connected to at least one of said bare and solid conductors via an integrally bonded connection.

33. The distribution system according to claim 19, wherein said insulating carrier is fastened to a supporting structure of the motor vehicle or is part of the supporting structure.

34. The distribution system according to claim 19, wherein the electrical system has a plurality of zones which are spatially spaced apart from one another and said supply line connects the plurality of zones to one another.

35. The distribution system according to claim 34, further comprising a plurality of decentralized control devices, wherein the zones each have one of said decentralized control devices and said supply line connects two of said decentralized control devices to each other.

36. The distribution system according to claim 19, wherein said supply line is one of two redundant supply lines which run parallel to one another in the motor vehicle from a front vehicle part to a rear vehicle part.

37. The distribution system according to claim 19, wherein at least two adjacent conductors of said bare and solid conductors have an identical potential during operation and are connected to one another.

38. A supply line for a distribution system, the supply line comprising:
a plurality of levels, each of said levels having an insulating carrier with a plurality of longitudinal grooves formed therein which are delimited from one another in an insulating manner and into said longitudinal grooves bare and solid conductors are disposed, each of said insulating carriers being in a form of a pre-manufactured component into which said bare and solid conductors are insertable retrospectively, and in that two said insulating carriers are disposed one above another.
